(19) United States
(12) Patent Application Publication
(10) Pub. No.: US 2017/0249349 A1
(43) Pub. Date: Aug. 31, 2017

(54) TECHNIQUES TO MANAGE A REMOTE DATA STORE FOR AN ELECTRONIC DEVICE

(71) Applicant: NETAPP, INC., Sunnyvale, CA (US)

(72) Inventors: Onkar Bhat, San Jose, CA (US); Sharad Jain, Sunnyvale, CA (US); Pramodh Pisupati, Sunnyvale, CA (US)

(73) Assignee: NETAPP, INC., Sunnyvale, CA (US)

(21) Appl. No.: 15/054,685

(22) Filed: Feb. 26, 2016

(51) Int. Cl. G06F 17/30

(52) U.S. Cl. CPC G06F 17/30371; G06F 17/30377; G06F 17/30321

(57) ABSTRACT

A remote data storage system for providing one or more mobile devices with a remote data store. The system may include a cloud platform with a storage management application and a data store. A mobile storage application may operate on a mobile device to enable the mobile device to interact with the storage management application. The storage management application may condition data for exchange between the mobile device and the data store. The conditioning of data may include the replacement of duplicate data subsets with references to equivalent data subsets. Other embodiments are described and claimed.

### BACKGROUND

Mobile devices such as smart phones or tablet computers typically include a local data store. The local data store can serve as a repository for data generated or utilized by the mobile device such as media (e.g., text, images, video, audio, etc.). Often the local data store does not have the storage capacity to store all of the data a user may desire. Accordingly, remote data stores have been used to provide mobile devices with additional storage capacity. Remote data stores can have much greater storage capacity relative to a local data store. Mobile devices typically upload data to the remote data store via a computer network such as the internet. Some remote data stores may utilize cloud storage techniques as a common, global repository for data that may be accessed and shared (e.g., served) across geographically separated data centers.

### BRIEF DESCRIPTION OF THE DRAWINGS

FIG. 1 illustrates an embodiment of a remote data storage system.

FIG. 2 illustrates an embodiment of a storage management application of an exemplary data deduplication system.

FIG. 3 illustrates an embodiment of an interface component of an exemplary storage management application.

FIG. 4 illustrates an embodiment of a verification component of an exemplary storage management application.

FIG. 5 illustrates an embodiment of an indexing component of an exemplary storage management application.

FIG. 6 illustrates an embodiment of a storage component of an exemplary storage management application.

FIG. 7 illustrates an embodiment of a data store of an exemplary data deduplication system.

FIG. 8 illustrates an embodiment of an assembler component of an exemplary storage management application.

FIG. 9 illustrates an example process flow for storing data with an embodiment of a storage management application.

FIG. 10 illustrates an example process flow for retrieving data with an embodiment of a storage management application.

FIG. 11 illustrates an embodiment of a mobile storage application of an exemplary data deduplication system.

FIG. 12 illustrates an embodiment of a mobile storage component of an exemplary mobile storage application.

FIG. 13 illustrates an embodiment of a mobile indexing component of an exemplary mobile storage application.

FIG. 14 illustrates an embodiment of a mobile interface component of an exemplary mobile storage application.

FIG. 15 illustrates an embodiment of a mobile device data store of an exemplary mobile storage application.

FIG. 16 illustrates an example process flow for storing data with an embodiment of a mobile storage application.

FIG. 17 illustrates an embodiment of a first logic flow.

FIG. 18 illustrates an embodiment of a second logic flow.

FIG. 19 illustrates an embodiment of a third logic flow.

FIG. 20 illustrates an embodiment of a storage medium.

FIG. 21 illustrates an embodiment of a computing architecture.

FIG. 22 illustrates an embodiment of a communications architecture.

### DETAILED DESCRIPTION

Various embodiments are generally directed to techniques for managing and utilizing a remote data store for an electronic device, such as a mobile device, for example. Some embodiments are particularly directed to remote data storage systems arranged to manage a data store for one or more mobile devices (e.g., tablet computer, smart phone, etc.). Management of the data store may include conditioning data for storage and retrieval from the data store by one or more mobile devices. Conditioning of data may be used to prevent multiple copies of data from being stored to the data store in the cloud platform while maintaining accessibility to the data. For instance, when a mobile device uploads data for storage, deduplication can be implemented to reduce or eliminate redundant storage of data in the data store of the cloud platform. Once duplicate data is identified, the duplicate data can be replaced with a reference to same or equivalent data to improve the efficiency with which storage space in the data store is utilized.

One challenge facing utilization of remote data stores for mobile devices is the ability to efficiently utilize storage space on the remote data store. Mobile devices typically have fewer compute, memory and communications resources relative to larger electronic devices (e.g., a desktop computer). Such limitations make it difficult for a mobile device to seamlessly store, manage and access data in a remote data store, such as remote data store implemented on a cloud platform. Furthermore, multiple copies of the same or equivalent data may be stored to the remote data store leading to unnecessary and inefficient use of storage space on the remote data store. Efficient storage space utilization relies, at least in part, on the ability to quickly identify duplicate data in a set of data and replace the duplicate data with a reference to equivalent data before the set of data is stored to the remote data store. To achieve this, the set of data needs to be quickly and efficiently compared to large quantities of existing data (e.g., gigabytes, terabytes, petabytes, etc.). This comparison can be time consuming and processor intensive resulting in an inefficient system. Adding further complexity, mobile devices may upload sets of data for storage in different formats or with different communication protocols. These different formats and protocols may make it difficult or impossible to quickly and accurately identify duplicate data in the sets of data to identify duplicate data and/or replace the duplicate data with a reference to equivalent data. All of these challenges contribute to inefficient systems and poor utilization of storage space in remote data stores for mobile devices.

Conventional solutions attempt to solve the difficulties associated with efficiently utilizing remote data stores for mobile devices by relying on backend systems to identify duplicate data already stored on the remote data store or requiring manual identification of duplicate data. It is impractical to accurately or efficiently manually identify duplicate data and replace the duplicate data with a reference to equivalent data. Also, identifying duplicate data only after it has been stored to a remote data store by a backend system significantly decreases the efficiency with which a remote data store is utilized because it requires unnecessary or redundant read and write operations. Such techniques may entail needless complexity, high costs, and poor efficiency.

To solve these and other problems, various embodiments include a storage management application interposed between one or more mobile devices and the remote data store to enable more efficient utilization of storage space on a remote data store. The storage management application may operate to identify data received from a mobile device as duplicative and prevent the duplicate data from being stored to the remote data store. Also, to solve these and other problems, some embodiments include a mobile storage application on the mobile device to provide a uniform interface between the mobile device and the storage management application.

In one embodiment, the storage management application may utilize key values to quickly and efficiently prevent a remote data store from storing duplicate data. For example, the storage management application may include an interface component, an indexing component, and a storage component. The interface component may receive a set of data from a mobile device via a defined interface, such as a representational state transfer (REST) framework, for example. The indexing component may generate a current key value for a subset of data from the set of data. The current key value may then be compared to one or more previous key values, such as key values previously generated from existing data on the remote data store, for example. Based on the comparison, the subset of data from which the current key value was generated may be identified as original or duplicate data. The storage component may create a storage object with the original data and a reference for the duplicate data, associate the storage object with an object identifier, and send the storage object to the remote data store for storage.

The use of a storage management application provides several advantages relative to conventional solutions. For example, using a storage management application may allow a mobile device to store, manage and access data from a remote data store without any hardware, software or firmware modifications needed at the mobile device. This greatly increases an amount of storage space available to a mobile device. Furthermore, a mobile device may benefit from increased storage capacity through increased use of its communications interface, thereby conserving compute, memory, and other on-device resources for other tasks. In addition, preventing duplicate data from being stored to the remote data store in this manner can result in a more accurate, reliable, and robust system. Further, it can improve the efficiency with which storage space on a remote data store is utilized.

With general reference to notations and nomenclature used herein, portion of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatus may be specially constructed for the required purpose or may include a general-purpose computer. The required structure for a variety of these machines will be apparent from the description given.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modification, equivalents, and alternatives within the scope of the claims.

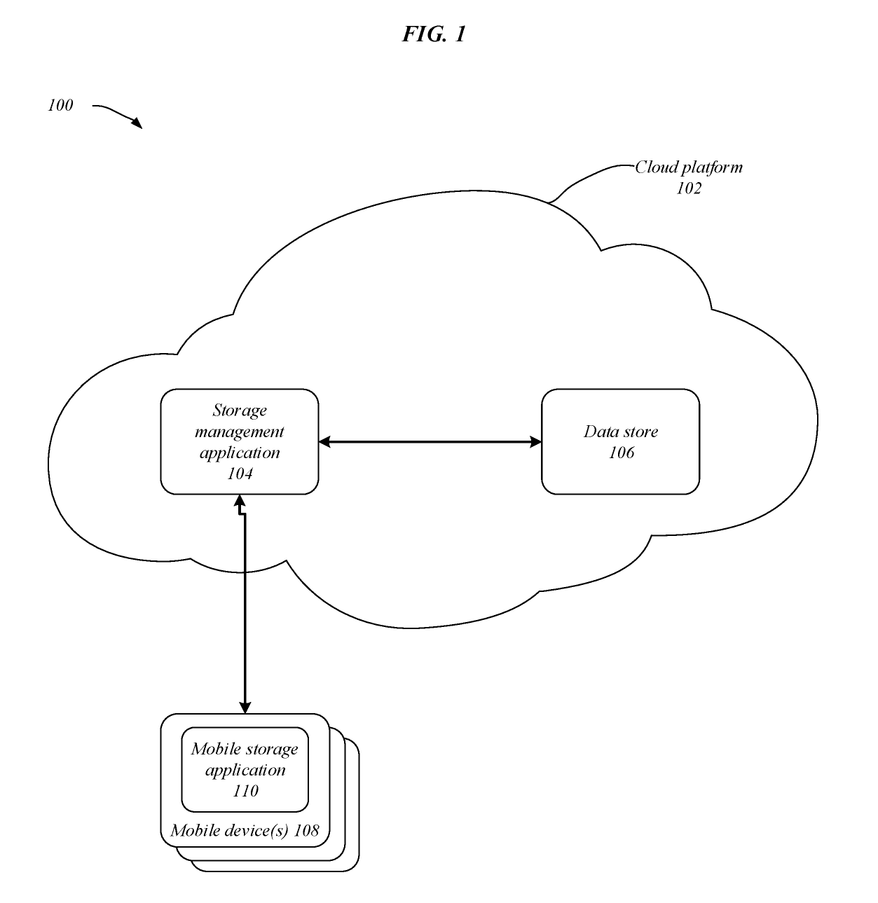

FIG. 1 illustrates one embodiment of remote data storage system 100. The remote data storage system 100 may be used to provide efficient data storage in a cloud platform 102. The cloud platform 102 can include a storage management application 104 and a data store 106. The data store 106 may serve as a remote data store for one or more mobile devices 108. Storage management application 104 may manage the data store 106 for the one or more mobile devices 108. Management of the data store 106 may include indexing, storage, and/or retrieval operations associated with the data store 106 as well as conditioning of data for storage and retrieval from data store 106. In various embodiments, the storage management application 104 may manage the data store 106 by selectively storing original data while excluding duplicate data. In various such embodiments, duplicate data may be replaced with a reference to a location from which data equivalent to the duplicate data can be retrieved. These and other features of the remote data store system 100 can allow efficient operation and utilization of a data store 106 in supporting one or more mobile devices 108. Embodiments are not limited in this context.

Cloud platform 102 may refer to any computing infrastructure that enables ubiquitous and on-demand network access to a pool of one or more resources, such as networks, servers, storage, applications, etc. (e.g. storage management application 104, data store 106). In some embodiments, one or more portions of the computing infrastructure of cloud platform 102 may be virtualized. For example, the storage management application 104 may be a virtual instance instantiated in a compute pool of the cloud platform 102. In another example, the data store 106 may be a virtual appliance instantiated in a storage pool of the cloud platform 102. In various embodiments the storage management application 104 and the data store 106 may operate in separate cloud platforms. In some embodiments storage management application 104 or data store 106 may be readily migrated between different cloud platforms.

The storage management application 104 may be interposed between one or more mobile devices 108 and data store 106 to facilitate interaction between the data store 106 and the one or more mobile devices 108. In various embodiments, the storage management application 104 may condition data received from a mobile device 108 before sending the data to the data store 106, and condition data received from the data store 106 before sending the data to a mobile device 108. For example, conditioning data received from a mobile device may include replacing duplicate data with a reference to the location from which data equivalent to the duplicate data can be retrieved from the data store 106. In another example, conditioning data received from the data store 106 may include retrieving data subsets using one or more duplicate data references to assemble a set of data requested by a mobile device.

Data store 106 may provide additional storage space and/or storage functionality (e.g., redundant array of independent disks (RAID), mirror, input/output (I/O) capacity, accessibility, etc.) to the one or more mobile devices 108. In some embodiments, the data store 106 may function with one or more arrays of flash memory. In other embodiments, the data store 106 functions with one or more disk drives. In further embodiments the data store 106 may function with a combination of one or more flash arrays and one or more disk drives. In various embodiments, data store 106 may refer to a hosted object storage service. In various such embodiments, the hosted object storage service may comprise cloud storage. Cloud storage may be made up of many distributed resources that act as a single resource from the perspective of the one or more mobile devices 108. In various embodiments, the cloud storage may be highly fault tolerant through redundancy and distribution of data and highly durable through the creation of versioned copies.

The one or more mobile devices 108 may include any mobile computing device that includes a processor and memory. Each mobile device 108 may include a mobile storage application 110 to utilize data store 106 by communicating with the storage management application 104. In some embodiments, the mobile storage application 110 may be stored on a memory of a mobile device 108 and be executed by a processor of the mobile device 108. Some examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In some embodiments, for example, a mobile computing device may be implemented as a smart phone capable of executing computer applications, as well as voice communications and/or data communications. Although some embodiments may be described with a mobile computing device implemented as a smartphone by way of example, it may be appreciated that other embodiments may be implemented using other wireless mobile computing devices as well.

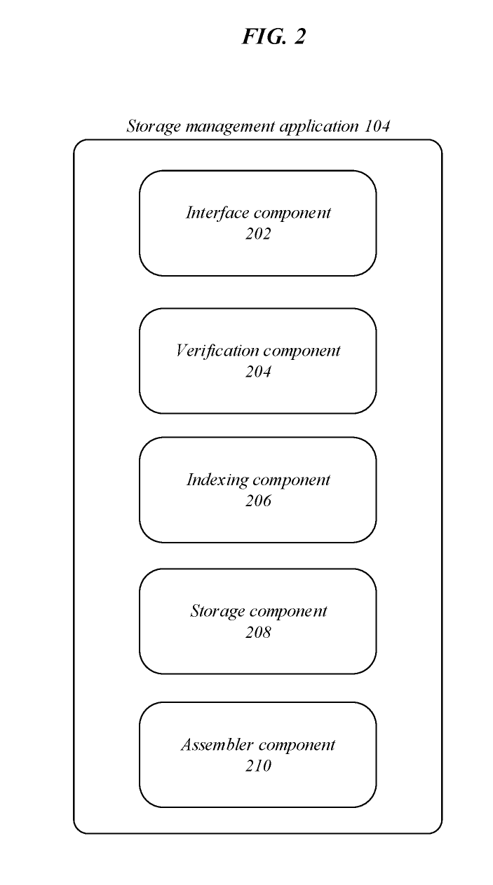

FIG. 2 illustrates an embodiment of the storage management application 104. The storage management application 104 may enable the remote data storage system 100 to improve storage space utilization on data store 106. To this end, data received from the one or more mobile device 108 at the mobile storage application 110 may be deduplicated prior to being stored to data store 106. Components of the storage management application 104 may manage data store 106 and condition data exchanged between one or more mobile devices 108 and the data store 106. The conditioning of data may enable the mobile device 108 to store and retrieve data from the data store 106, while duplicate data may be identified and replaced with a reference to equivalent data to improve storage space utilization. Embodiments are not limited in this context.

As shown in FIG. 2, the storage management application 104 may include an interface component 202, a verification component 204, an indexing component 206, a storage component 208, and an assembler component 210. The components may interoperate to manage data store 106 and condition data for exchange between the mobile device 108 and data store 106. In some embodiments, the management of data store 106 and conditioning of data for exchange may include one or more steps of interfacing with mobile device 108 via mobile storage application 110, receiving data, verifying credentials associated with a client, indexing received data, removing duplicate data, sending data for storage in data store 106, and assembling data requested from data store 106.

In some embodiments multiple instances of the storage management application 104 may be instantiated in to handle requests from a plurality of mobile devices. In various embodiments one or more components of the storage management application 104 may be remote from the storage management application 104. In various such embodiments the function of the remote component may be achieved with I/O requests sent and received from a remote server. In some embodiments, the storage management application 104 may function with one or more processors such as in one or more servers.

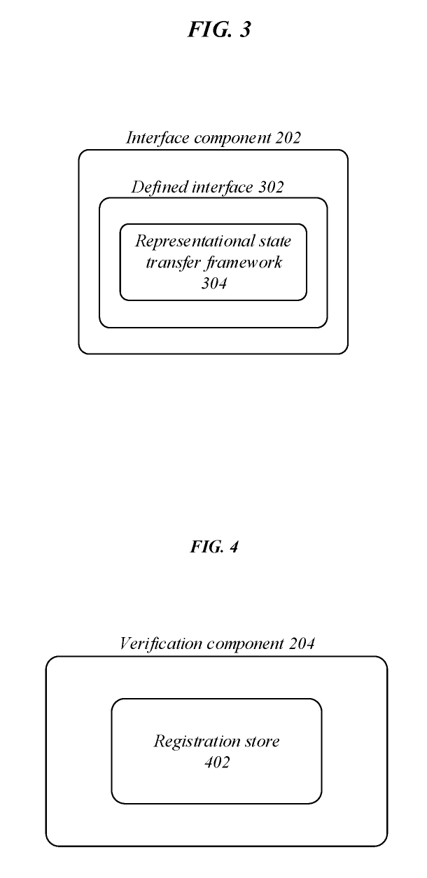

FIG. 3 illustrates an embodiments of interface component 202. The interface component 202 may enable the storage management application 104 to communicate with mobile device 108. This communication may include any exchange of data with the mobile device 108 to enable one or more embodiments described herein. In some embodiments the interface component 202 may also enable the storage management application 104 to communicate with the data store 106. Embodiments are not limited in this context.

The interface component 202 may include a defined interface 302. Defined interface 302 may include any schema, protocol, and/or framework utilized for sending a receiving communications over a computer network. In the illustrated embodiment, the defined interface 302 includes a representational state transfer (REST) framework 304. The REST framework 304 may enable stateless communication between the storage management application 104 and one or more other portions of the remote data storage system 100. Stateless communication may include independent pairs of request and response. In other words, each request includes all the information necessary to service the request. For example, a request from mobile device 108 may include an object identifier 710 (see FIG. 7) to indicate to the storage management application 104 which data to retrieve from the data store 106 and return to the mobile device 108 in a response.

FIG. 4 illustrates an embodiment of verification component 204. The verification component 204 may enable the storage management application 104 to validate credentials associated with data store 106. The credentials may include an access key. The access key may be used to initialize the mobile storage application 110 on mobile device 108. Embodiments are not limited in this context.

In some embodiments, the access key may be obtained when a client registers for the remote data storage system. Registration may cause instantiation of a virtual instance of the storage management application 104 in the cloud platform 102. In various embodiments, the virtual instance may be associated with the access key. In various such embodiments, requests received by the storage management application 104 may be validated by the verification component using the access key. In some embodiments requests are received from a plurality of mobile devices 108 that utilize data store 106.

To validate the requests the verification component 204 may compare the received access key to a registration store 402. In some embodiments, the registration store 402 may include the access key that the storage management application 104 was associated with when it was instantiated in the cloud platform 102. In some embodiments requests received at the cloud platform 102 may be directed to the virtual instance based on an included access key.

The access key may be used to initialize the mobile storage application 110 on mobile device 108. In some embodiments initialization of the mobile storage application 110 verifies functionality of the remote data storage system 100. Verification of functionality may include storing and/or retrieving test data from the data store 106.

The verification component 204 may also provide cryptographic services to the storage management application 104. For example, the verification component 204 may encrypt/decrypt data sent/received to/from mobile storage application 110 or data store 106. In some embodiments, the verification component 204 may utilize one or more of symmetric key encryption and public key encryption.

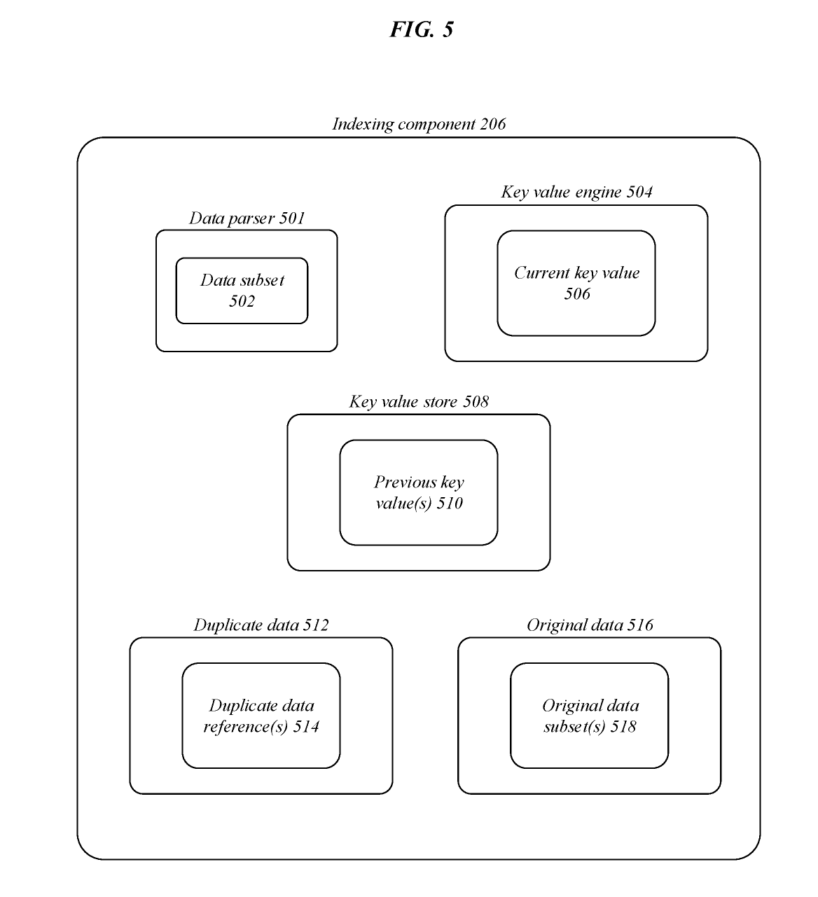

FIG. 5 illustrates an embodiment of indexing component 206. The indexing component 206 may enable the storage management application 104 to identify duplicate data in a set of data received for storage in data store 106. To this end, the indexing component may break down a set of data into subsets and compare the subsets of data to one or more subsets of data stored in data store 106. This comparison may be achieved by generating key values for the subsets of the received set of data and comparing these key values to one or more previous key values generated based on the one or more subsets of data stored in data store 106. Embodiments are not limited in this context.

As shown in FIG. 5, the indexing component 206 may include a data parser 501, a key value engine 504, a key value store 508, duplicate data 512, and original data 516. The data parser 501 may include data subset 502. Data subset 502 may be generated by the data parser 501 in response to receiving and/or validating a request to store a set of data in data store 106. In some embodiments a plurality of data subsets compose the set of data or data set. Key value engine 504 may generate a current key value 506 for the data subset 501. The current key value 506 may be compared to one or more previous key values 510 stored in key value store 508. In some embodiments the key value store 508 may be remote to the storage management application 104.

In various embodiments, the key value engine 504 may use a hash function on each subset of data received from the data parser 501 to generate a current key value 506. In various such embodiments, comparison of current and previous key values 506, 510 may utilize a hash table to differentiate duplicate and original data 512, 516. In some embodiments, one or more of the previous key values 510 may have been generated by the key value engine 504. In various embodiments, a current key value 506 may become a previous key value 510 when it is stored to the key value store 508.

When a current key value 506 matches a previous key value the indexing component 206 may identify the data subset 502 as duplicate data 512. Duplicate data 512 may be conditioned by replacing it with one or more duplicate data references 514. Each duplicate data reference 514 may include a reference, such as a pointer, to a location of data equivalent to the data subset 502 that the current key value 506 was generated from. In some embodiments, the data equivalent to the data subset 502 may be located on the data store 106. In other embodiments, the data equivalent to the data subset 502 may be location remote to data store 106.

In some embodiments, the duplicate data reference 514 may comprise a previous key value 510. When a current key value 506 does not match a previous key value in the key value store 508 the data subset 502 may be considered an original data subset 518 of original data 516. Original data subsets 518 and duplicate data references 514 from the received set of data may then be passed to storage component 208.

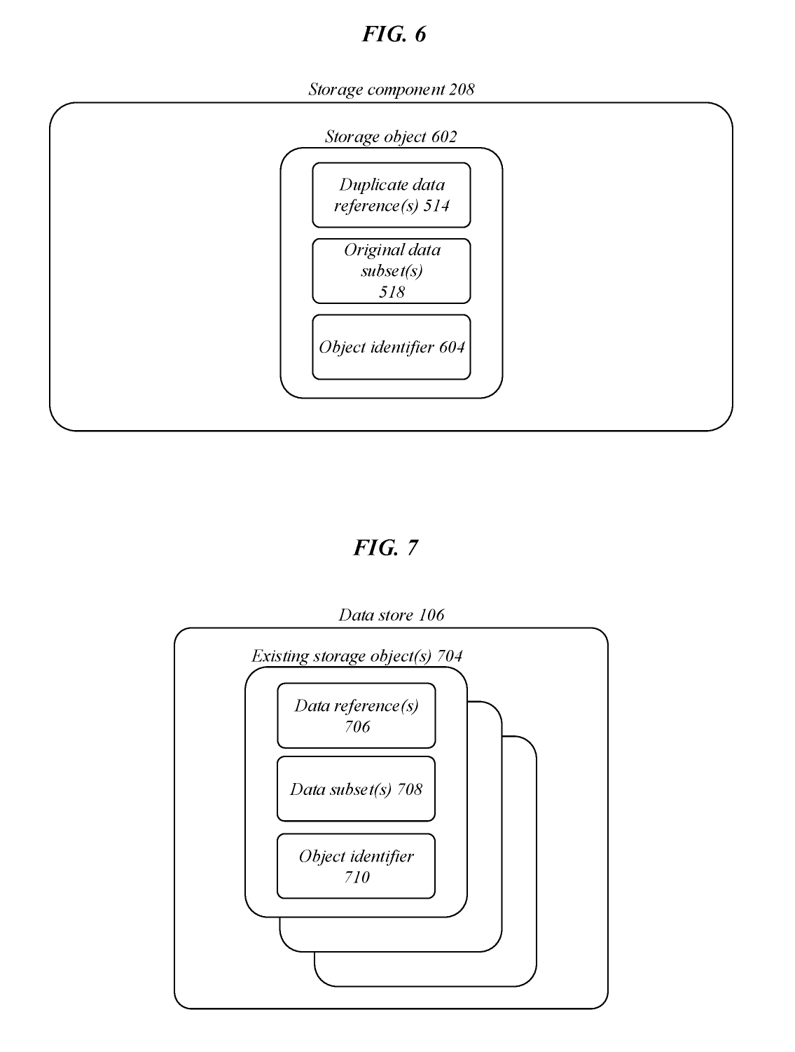

FIG. 6 illustrates an embodiment of storage component 208. Storage component 208 may create a storage object 602 for storing a set of data to the data store 106. To this end, storage object 602 may not include every subset of data composing the set of data, however the storage object 602 may still include sufficient data for assembler component 210 to reconstruct the data set in its entirety. Thus any subsets of the data set not included storage object 602 as original data subsets 518 are represented by duplicate data references 514. Storage component 208 may generate an object identifier 604 for storage object 602. Object identifier 604 may uniquely identify storage object 602 and/or the set of data storage object 602 was created for. Embodiments are not limited in this context.

In the illustrated embodiment, storage component 208 may include duplicate data references 514, original data subsets 518, and object identifier 604. In various embodiments, the object identifier 604 may be generated by applying a hash function to the one or more original data subsets 518. In other embodiments, the object identifier 605 may be generated by applying a hash function to one or more key values associated with original data subsets 518. In some embodiments, object identifier 604 includes a uniform resource identifier (URI).

In some embodiments, storage component 208 may store storage object 602 to data store 106 by sending storage object 602 to data store 106 in a REST call. In various embodiments storage component 208 may compress data before including the data in the storage object 602. In some embodiments, storage component 208 may compress storage object 602 before storing the storage object 602 to data store 106.

FIG. 7 illustrates an embodiment of data store 106. Data store 106 may include one or more existing storage objects 704. Each existing storage object may include one or more data references 706 and one or more data subsets 708. An object identifier 710 may also be included to uniquely identify each storage object. When a storage object 602 is received from the storage management application 104 and stored in data store 106 it may be referred to as an existing storage object 704. In various embodiments, existing storage objects 702 may include storage objects not received from a mobile device 108. In various such embodiments, the key value store 508 may still include key values generated from storage objects not received from a mobile device 108. Embodiments are not limited in this context.

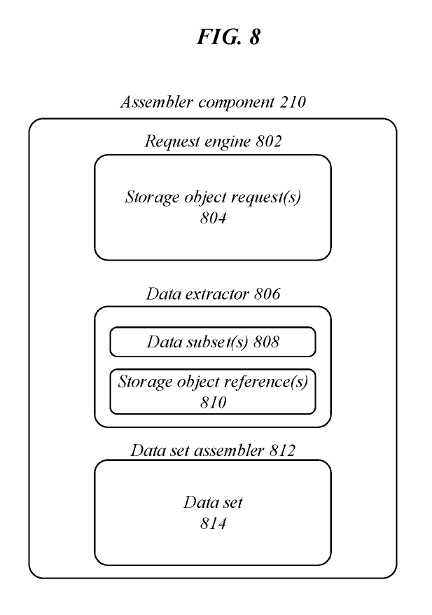

FIG. 8 illustrates an embodiment of assembler component 210. The assembler component 210 can enable the storage management application 104 to retrieve a data set 814 accessible to the remote data storage system 100. A request received from mobile storage application 110 may identify a set of data (e.g., data set 814) for retrieval. The data set 814 may be stored in the data store 106 as existing storage objects 704. The assembler component 210 reconstruct the data set from one or more existing storage objects 704. In some embodiments the assembler component 210 may also utilize storage objects remote to the data store 106. Embodiments are not limited in this context.

As shown in FIG. 8, the assembler component 210 may include a request engine 802, a data extractor 806, and a data set assembler 812. The request engine 802 may generate storage object requests 804 to fulfil a request for data set 814 received by the storage management application 104. The storage object requests 804 may be used to retrieve storage objects that include subsets of data (e.g., data subset 808) in the data set 814. In some embodiments one or more of the storage objects may be located remote to data store 106.

The data extractor 806 may extract data subset 808 and storage object reference 810 from the requested storage objects. The data subset 808 may include a portion of the requested data set 814. The storage object reference 810 may indicate the location of an additional data subset of the requested data set. The location may be utilized by request engine 802 to generate another storage object request 808. This process may be repeated a number of times until all data subsets 808 composing the requested data set 814 have been extracted. Once all the data subsets 808 of the requested data set have been extracted, the data set assembler 812 may order the data subsets 808 to assemble the data set 814.

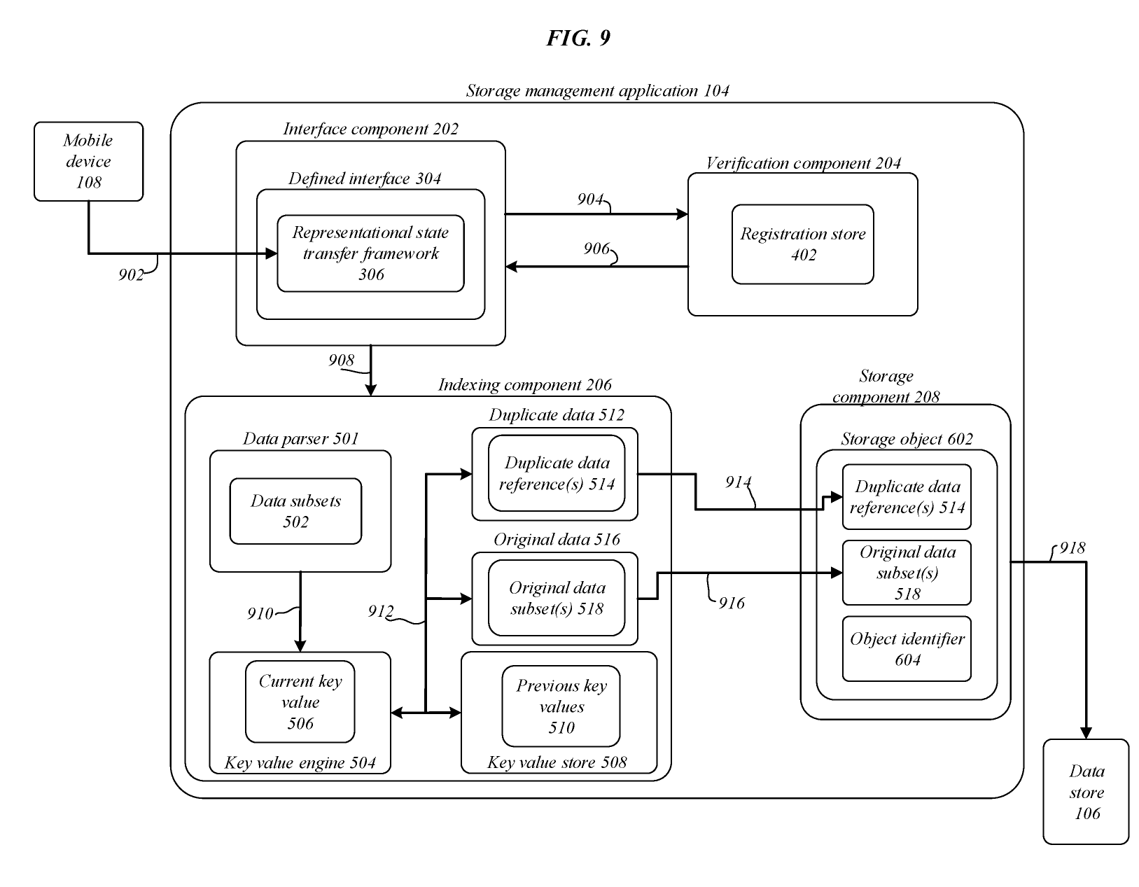

FIG. 9 illustrates an example process flow for storing data with storage management application 104. In the exemplary process flow, the interface, verification, indexing, and storage components 202, 204, 206, 208 are utilized by the storage management application 104. Mobile device 108 may provide a set of data (e.g., data set 1204, see FIG. 12) for storage in data store 106. The storage management application 104 may receive and condition the data set before sending it to data store 106 for storage. Embodiments are not limited in this context.

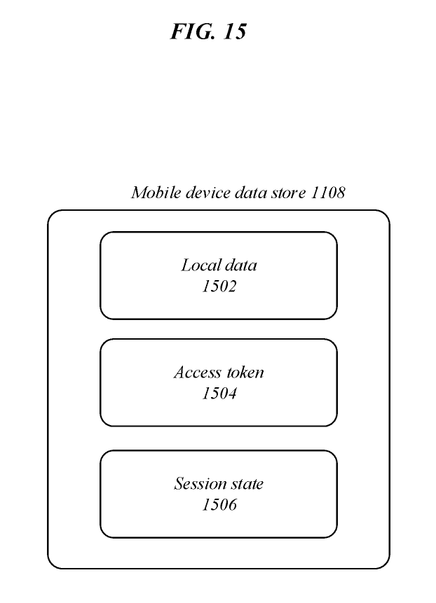

At 902, the storage management application 104 may receive a request to store a data set in data store 106. In the illustrated embodiment the request includes a REST call with an access token (e.g. access token 1504, see FIG. 15) and the data set for storage. The REST call may be received via REST framework 306. The defined interface 304 for the interface component 202 may include REST framework 306. The access token may be passed to the verification component 204 at 904. The verification component 204 may compare the access token to registration data store 402 to validate the request. At 906 validation of the request may be indicated to the interface component 202. In response, the interface component 202 may pass the data set to indexing component 206.

The data parser 501 may receive the data set and generate one or more data subsets 502. At 910 a data subset may be passed to key value engine 504. The key value engine 504 may generate current key value 506 based on the data subset. At 912 the current key value 506 may be compared to one or more previous key values 510 in key value store 508. When the current key value matches a previous key value, the data subset 502 may be identified as duplicate data 512. A duplicate data reference 514 may be utilized to replace the data subset 502 before the data set is stored to data store 106. Duplicate data 512 may include one or more duplicate data references 514.

When the current key value 506 does not match a previous key value 510, the data subset 502 may remain as original data 516. In other words, original data subsets 518 may include one or more portions of the data set that are not associated with a previous key value. Original data 516 may include one or more original data subsets 518 for storage in the data store 106.

At 914, the duplicate data references 514 are provided to storage component 208 and at 916 original data subsets 518 are provided to storage component 208. The storage component 208 may create storage object 602. Storage object 602 may include duplicate data references 514, original data subsets 518, and object identifier 604. Object identifier 604 may be generated by the storage component 208. The object identifier 604 may function to uniquely identify the storage object 602 to enable retrieval of the storage object 602. At 918, the storage object 602 may be sent to data store 106 for storage. In some embodiments storage object 602 may be sent to data store 106 as a REST call.

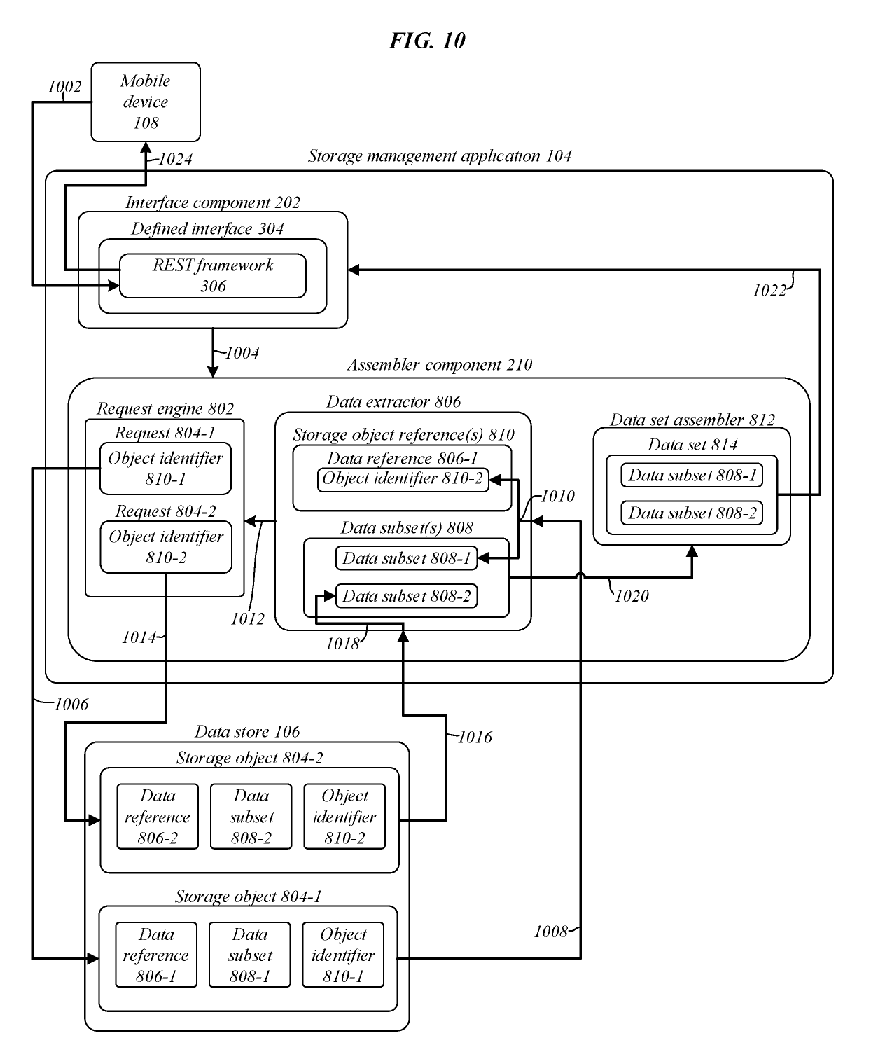

FIG. 10 illustrates an example process flow for retrieving data with storage management application 104. In the exemplary process flow, the interface and assembler components 202, 210 are utilized by the storage management application 104. Mobile device 108 may provide a REST call requesting a set of data (e.g., data set 814, see FIG. 8) for retrieval from data store 106. The storage management application 104 may receive and condition the data set from data store 106 before sending it to mobile device 108. Embodiments are not limited in this context.

At 1002, the storage management application 104 may receive a request for a data set in data store 106. In the illustrated embodiment the request includes a REST call with an object identifier 810-1. The REST call may be received via REST framework 306. The defined interface 304 for the interface component 202 may include REST framework 306. The object identifier 810-1 may be passed to the assembler component 210 at 1004. The request engine 804 of the assembler component may generate request 804-1 based on object identifier 810-1. At 1006, request 804-1 may be sent to data store 106. In some embodiments, request 804-1 may be a REST call.

At 1008 storage object 804-1 may be received by the data extractor 806 of the assembler component 210. In some embodiments, storage object 804-1 may be received in a REST response. The data extractor 806 may extract data subset 808-1 and object identifier 810-2 from storage object 804-1 at 1010. Object identifier 810-2 may be passed to request engine 802 at 1012. Based on object identifier 810-2, request engine 802 may generate request 804-2. At 1014, request 804-2 may be sent to data store 106. In some embodiments, request 804-2 may be a REST call. At 1016, storage object 804-2 may be received by the data extractor 806. In some embodiments, storage object 804-2 may be received in a REST response. Data extractor 706 may extract data subset 808-2 from storage object 804-2 at 1018.

Data set assembler 812 may receive data subsets 808-1 and 808-2 at 1020. The data set assembler 812 may order the data subsets to assemble data set 814. At 1022, data set 814 may be passed to interface component 202. Interface component 202 may send the data set 814 to mobile device 108 via REST framework 306 at 1024. In some embodiments the data set 814 may be sent to the mobile device 108 as a REST response.

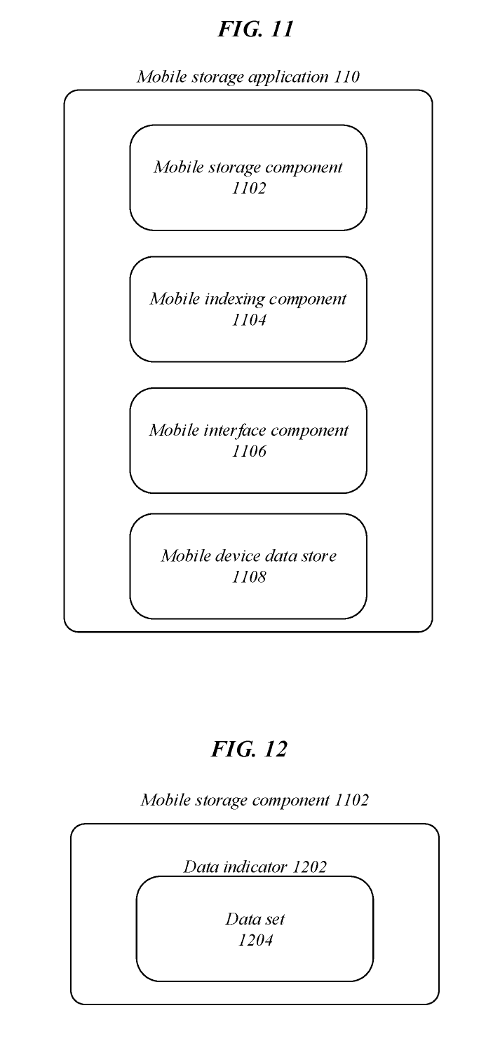

FIG. 11 illustrates an embodiment of the mobile storage application 110. The mobile storage application 110 may enable the remote data storage system 100 to improve storage space utilization on data store 106. To this end, mobile storage application 110 may enable mobile device 108 to interact with the storage management application 104. Interaction with the storage management application 104 may include any operations to transfer data to and from mobile device 108. Interaction with the storage management application may enable mobile device 108 to store and retrieve data from data store 106. Embodiments are not limited in this context.

As shown in FIG. 11, the storage management application 104 may include a mobile storage component 1102, a mobile indexing component 1104, a mobile interface component 1106, and a mobile device data store 1108. The components may interoperate to enable the mobile storage application 110 to interact with the storage management application 104. In some embodiments this communication may occur over a REST framework 1404 (see FIG. 14). In various embodiments, interaction with the storage management application 104 may include one or more steps of monitoring data store on mobile device 108, identifying data on mobile device 108 for storage in data store 106, providing credentials to storage management application 104, indexing data stored on data store 106, and interfacing with storage management application 104.

In various embodiments one or more components of the mobile storage application 110 may be remote from the mobile storage application 110. In various such embodiments the function of the remote component may be achieved with I/O requests sent and received from a remote server or another component of mobile device 108. In some embodiments, the mobile storage application 110 may utilize one or more radios of the mobile device 108 to communicate with the storage management application 104.

FIG. 12 illustrates one embodiment of mobile storage component 1102. Mobile storage component 1102 may monitor data (e.g., local data 1502, see FIG. 15) on mobile device 108. Data indicator 1202 of the mobile storage component 1102 may identify a data set 1204 for storage to data store 106 based on monitoring of the data. Embodiments are not limited in this context.

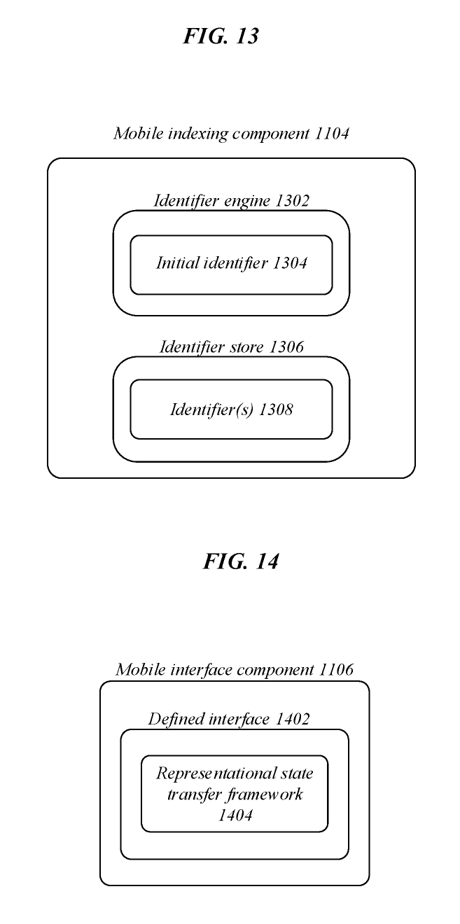

FIG. 13 illustrates an embodiment of mobile indexing component 1104. Mobile indexing component 1104 may track data stored to data store 106 and associated with mobile device 108 (e.g. data set 1204). Tracking data stored to data store 106 may enable remote data storage system 100 to store and retrieve data in an efficient manner. Embodiments are not limited in this context.

Mobile indexing component 1104 may include identifier engine 1302 and identifier store 1306. Identifier engine 1302 may be used by the mobile indexing component 1104 to associate a data set (e.g., data set 1204) with an initial identifier 1304. Identifier store 1306 may include one or more identifiers 1308 that map to one or more sets of data located on data store 106. In some embodiments, initial identifier 1304 is stored in identifier store 1308. In various embodiments, when the set of data is stored in data store 106, the mobile storage application 108 may receive an updated identifier associated with the set of data and stores the updated identifier to identifier store 1306. In some such embodiments, the updated identifier may replace the initial identifier 1304 in the identifier store 1306. In various embodiments the updated identifier may include an object identifier such as a uniform resource identifier (URI).

FIG. 14 illustrates an embodiments of mobile interface component 1106. The mobile interface component 1106 may enable the mobile device 108 to communicate with storage management application 104 via mobile storage application 110. This communication may include any exchange of data with the storage management application 104 to enable one or more embodiments described herein. In some embodiments the mobile interface component 1106 may also enable the mobile device 108 to communicate with the data store 106. Embodiments are not limited in this context.

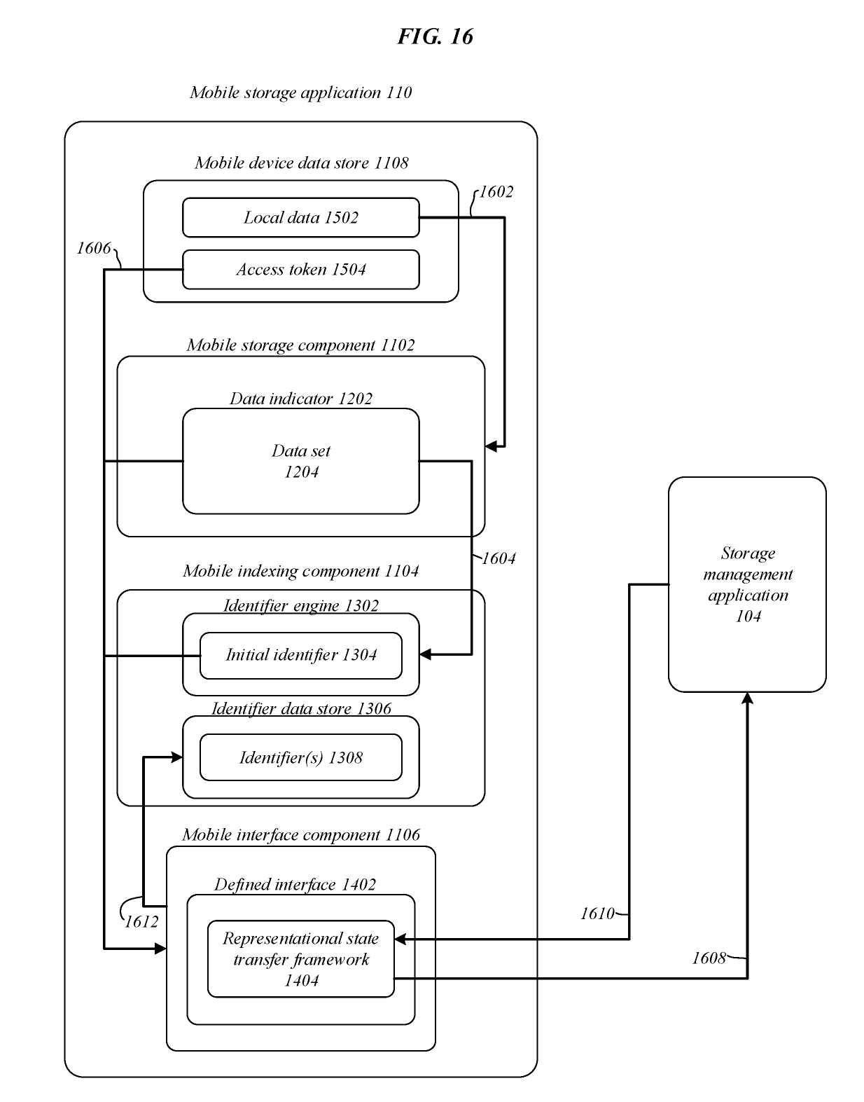

The interface component 1106 may include a defined interface 1402. Defined interface 1402 may include any schema, protocol, and/or framework utilized for sending a receiving communications over a computer network. In the illustrated embodiment, the defined interface 1402 includes a representational state transfer (REST) framework 1404. The REST framework 1404 may enable stateless communication between the mobile storage application 110 and one or more other portions of the remote data storage system 100. Stateless communication may include independent pairs of request and response. In other words, each request includes all the information necessary to service the request. For example, a request generated by mobile device 108 via the mobile storage application 110 may include a data set 1204 (see FIG. 16) to indicate to the storage management application 104 which data to deduplicate and/or store to the data store 106.

FIG. 15 illustrates an embodiment of a mobile device data store 1108. The mobile device data store may store data to enable the mobile storage application 110 to interact with the storage management application 104. In some embodiments, local data 1502 of the mobile device data store 1108 may be monitored by the storage component 1102 to identify one or more sets of data for storage to data store 106. Embodiments are not limited in this context.

The mobile device data store 1108 may include local data 1502, access token 1504, and session state 1506. Local data 1502 may include data generated or utilized by mobile device 108. Access token 1504 may enable requests and responses sent and received by mobile storage application 110 to be validated and/or routed to storage management application 104. Session state 1506 may include information relative to one or more previous communications with storage management application 104. In some embodiments session state 1506 includes initial identifier 1304. In some embodiments session state 1506 includes identifier store 1306.

FIG. 16 illustrates an example process flow for storing data with mobile storage application 110. In the exemplary process flow, the mobile device data store 1108, mobile storage component 1102, mobile indexing component 1104, and mobile interface component 1106 are utilized by the storage management application 104. Mobile storage application 110 may identify a set of data (e.g., data set 1204) for storage in data store 106. The mobile storage application 110 may generate a one or more requests to store the set of data to data store 106. In some embodiments the one or more requests include one or more of access token 1504, data set 1204, and initial identifier 1304. In response to the one or more requests, the mobile storage application 110 may receive an updated identifier for subsequent retrieval of the stored set of data. Embodiments are not limited in this context.

At 1602, mobile storage component 1102 may identify data set 1204 for storage from local data 1502 in the mobile device data store 1108 with data indicator 1202. The mobile indexing component 1104 may generate initial identifier 1304 based on data set 1204 at 1604. At 1606, access token 1504, data set 1204, and initial identifier 1304 may be passed to mobile interface component 1106.

At 1608, the mobile interface component 1106 may send a request to store data set 1204 in data store 106 to storage management application 104. In the illustrated embodiment the request includes a REST call with access token 1504, data set 1204, and initial identifier 1304. The REST call may be sent via REST framework 1404. The defined interface 1402 for the interface mobile interface component 1106 may include REST framework 1404. Upon processing the request to store data set 1204, storage management application 104 may send the status of the request to store data set 1204 at 1610.

In some embodiments the status may indicate whether or not the requests operation was successful. The status of the request to store data set 1204 received at 1610 may include an updated identifier associated with data set 1204. In some embodiments, the status of the request to store data set 1204 is received as a REST response. At 1612, the updated identifier may be stored as an identifier 1308 in identifier data store 1306. In some embodiments the updated identifier replaces or causes the initial identifier 1304 to be invalidated by mobile storage application 110.

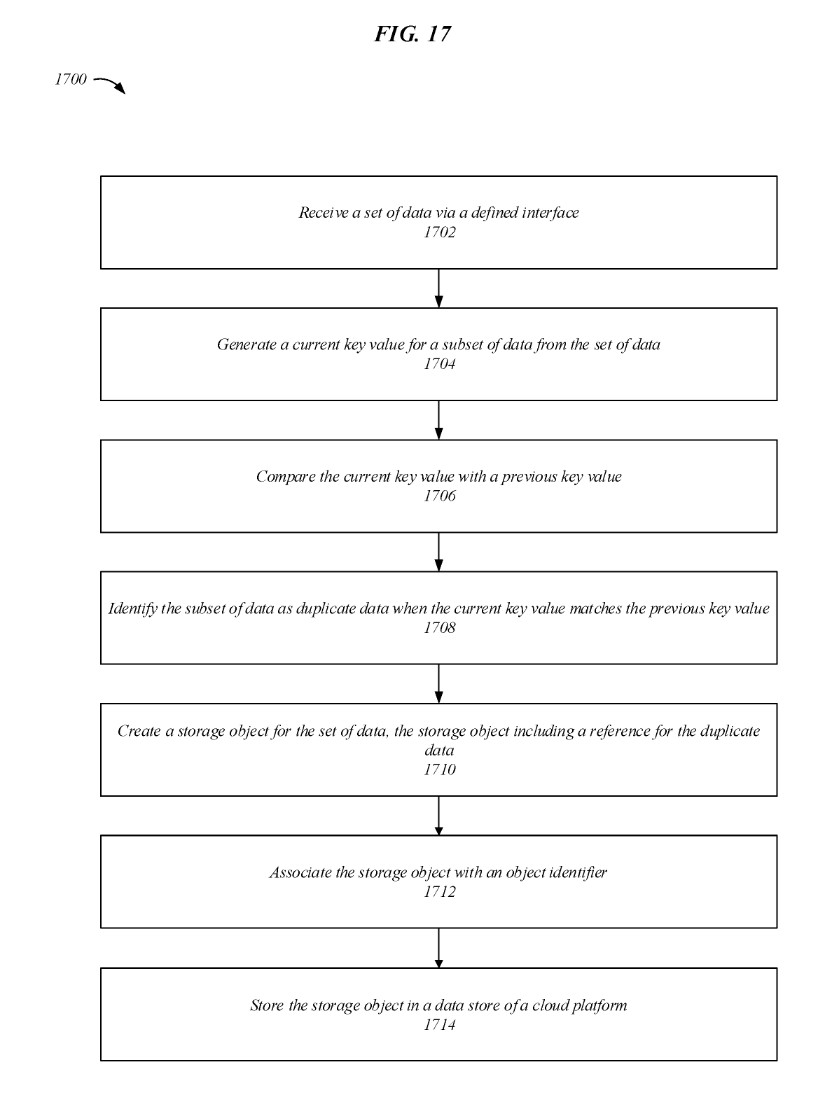

FIG. 17 illustrates one embodiment of a logic flow 1700. The logic flow 1700 may be representative of some or all of the operations executed by one or more embodiments described herein, such as the system 100 or the storage management application 104. Embodiments are not limited in this context.

In the illustrated embodiment shown in FIG. 17, the logic flow 1700 may receive a set of data via a defined interface at 1702. For example, data set 1204 may be received by the storage management application 104. A current key value may be generated for a subset of data from the set of data at 1704. At 1706 the current key value may be compared with a previous key value.

The subset of data may be identified as duplicate data when the current key value matches the previous key value at 1708. At 1710 a storage object for the set of data may be created. The storage object may include a reference for the duplicate data. At 1712, the storage object may be associated with an object identifier. The audio signals may be captured from the defined physical space 102. The logic flow 1700 may store the storage object in a data store of a cloud platform at block 1714. In some embodiments the storage object is stored to the data store of the cloud platform by sending a REST call to data store 106.

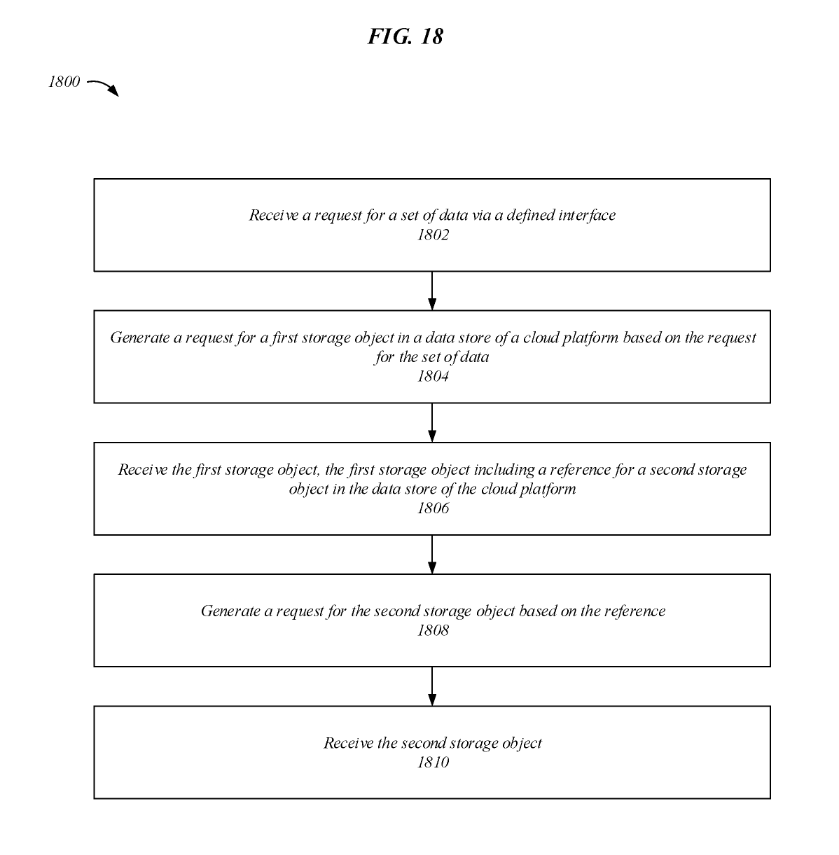

FIG. 18 illustrates one embodiment of a logic flow 1800. The logic flow 1800 may be representative of some or all of the operations executed by one or more embodiments described herein, such as the system 100 or the storage management application 104. Embodiments are not limited in this context.

In the illustrated embodiment shown in FIG. 18, the logic flow 1800 may receive a request for a set of data via a defined interface at block 1802. In some embodiments, the defined interface includes a REST framework. At 1804, a request for a first storage object in a data store of a cloud platform may be generated based on the request for the set of data. The first storage object may be received at 1806. The received first storage object may include a reference for a second storage object in the data store of the cloud platform. At block 1808, a request for the second storage object may be generated. The second storage object may be received at 1810.

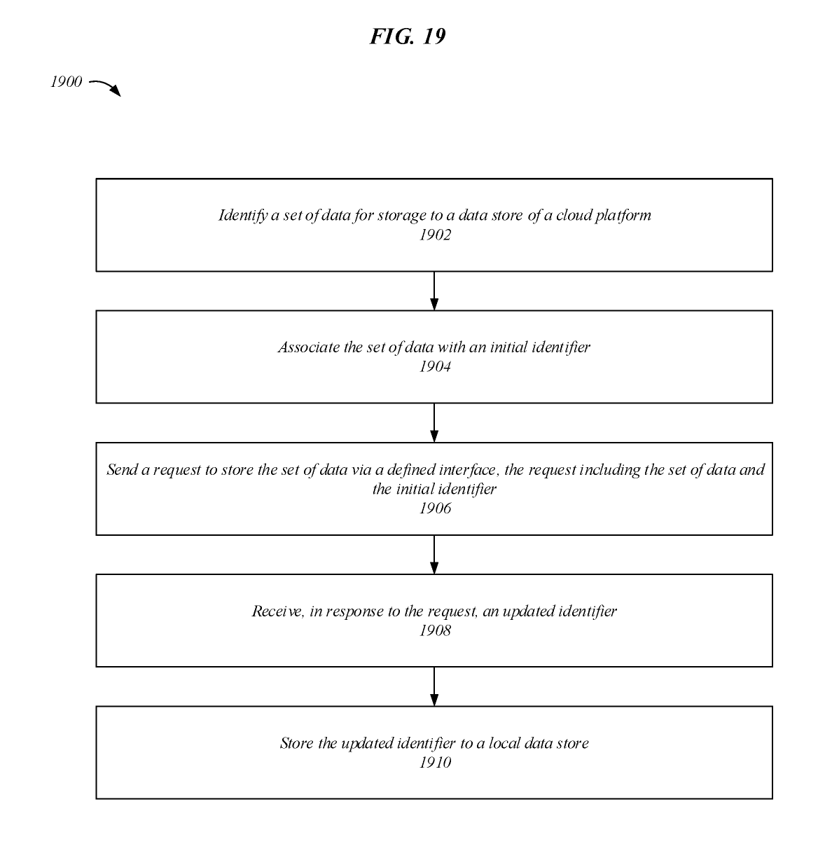

FIG. 19 illustrates one embodiment of a logic flow 1900. The logic flow 1900 may be representative of some or all of the operations executed by one or more embodiments described herein, such as the system 100 or the mobile storage application 110. Embodiments are not limited in this context.

In the illustrated embodiment shown in FIG. 19, the logic flow 1900 may identify a set of data for storage to a data store of a cloud platform at block 1902. The set of data may be associated with an initial identifier at 1904. At 1906, a request to store the set of data may be sent via a defined interface. The request may include the set of data and the initial identifier. In some embodiments the request may include a REST call. At block 1908, an updated identifier may be received in response to the request. In some embodiment the response to the request may include a REST response. At block 1910, the updated identifier may be stored to a local data store. For example, the updated identifier may be stored to identifier store 1306.

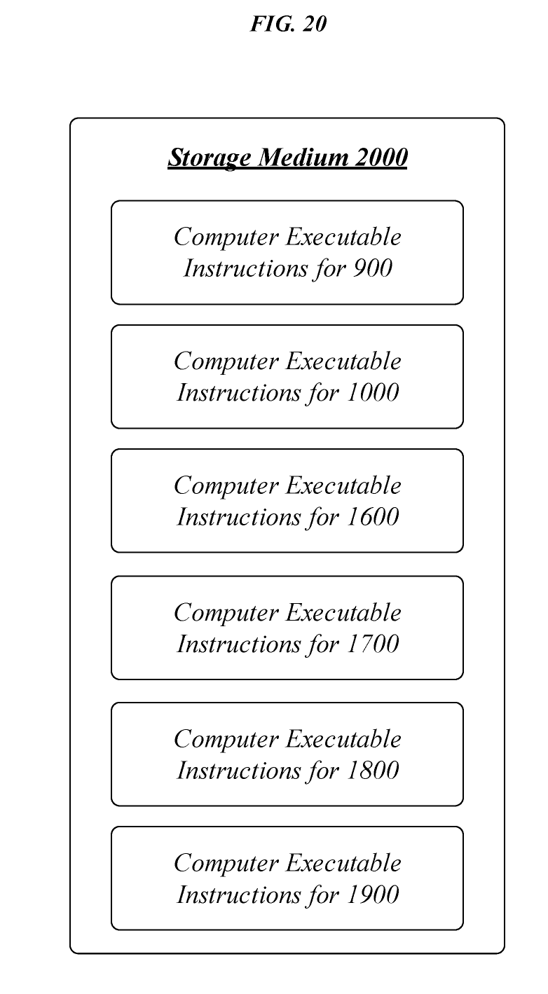

FIG. 20 illustrates an embodiment of a storage medium 2000. Storage medium 2000 may comprise any non-transitory computer-readable storage medium or machine-readable storage medium, such as an optical, magnetic or semiconductor storage medium. In various embodiments, storage medium 1800 may comprise an article of manufacture. In some embodiments, storage medium 1800 may store computer-executable instructions, such as computer-executable instructions to implement one or more of logic flows 900, 1000, 1600, 1700, 1800, 1900 FIGS. 9, 10, and 16-19. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

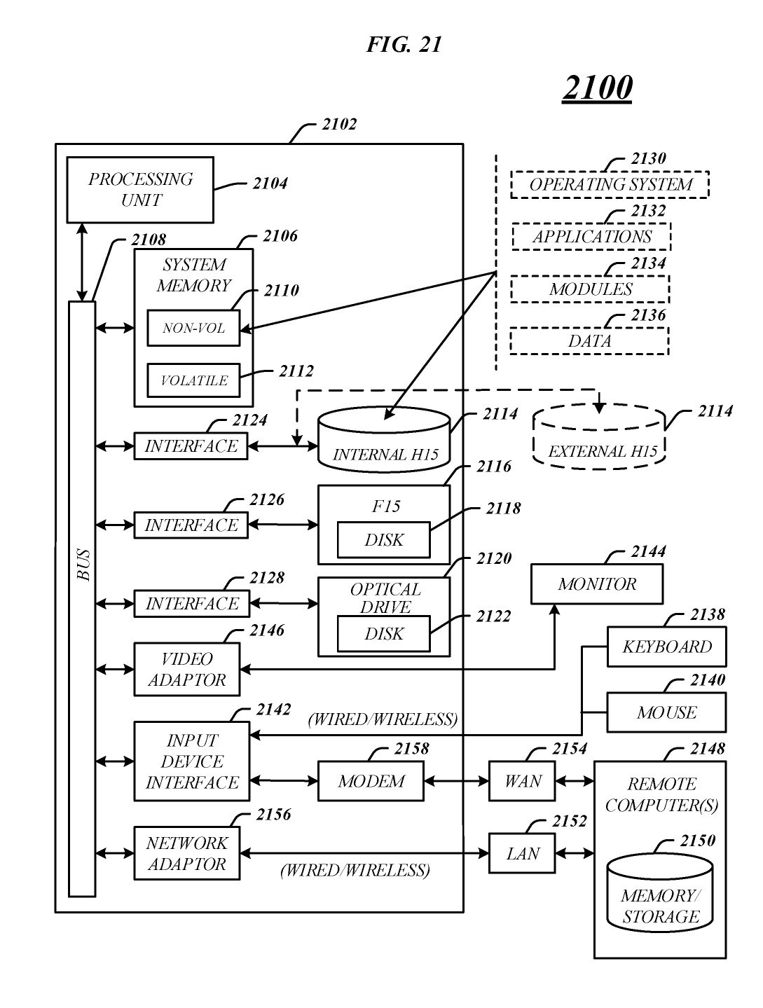

FIG. 21 illustrates an embodiment of an exemplary computing architecture 2100 that may be suitable for implementing various embodiments as previously described. In various embodiments, the computing architecture 2100 may comprise or be implemented as part of an electronic device. In some embodiments, the computing architecture 2100 may be representative, for example, of a processor server that implements one or more components of the storage management application 104. In some embodiments, computing architecture 2100 may be representative, for example, of a mobile device that implements one or more component of mobile storage application 110. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 2100. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 2100 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 2100.

As shown in FIG. 21, the computing architecture 2100 comprises a processing unit 2104, a system memory 2106 and a system bus 2108. The processing unit 2104 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 2104.

The system bus 2108 provides an interface for system components including, but not limited to, the system memory 2106 to the processing unit 2104. The system bus 2108 can be any of several types of bus structure that may further interconnect to a memory bus (with or without a memory controller), a peripheral bus, and a local bus using any of a variety of commercially available bus architectures. Interface adapters may connect to the system bus 2108 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 2106 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 21, the system memory 2106 can include non-volatile memory 2110 and/or volatile memory 2112. A basic input/output system (BIOS) can be stored in the non-volatile memory 2110.

The computer 2102 may include various types of computer-readable storage media in the form of one or more lower speed memory units, including an internal (or external) hard disk drive (HDD) 2114, a magnetic floppy disk drive (FDD) 2116 to read from or write to a removable magnetic disk 2118, and an optical disk drive 2120 to read from or write to a removable optical disk 2122 (e.g., a CD-ROM or DVD). The HDD 2114, FDD 2116 and optical disk drive 2120 can be connected to the system bus 2108 by a HDD interface 2124, an FDD interface 2126 and an optical drive interface 2128, respectively. The HDD interface 2124 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 2110, 2112, including an operating system 2130, one or more application programs 2132, other program modules 2134, and program data 2136. In one embodiment, the one or more application programs 2132, other program modules 2134, and program data 2136 can include, for example, the various applications and/or components of the system 100.

A user can enter commands and information into the computer 2102 through one or more wire/wireless input devices, for example, a keyboard 2138 and a pointing device, such as a mouse 2140. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 2104 through an input device interface 2142 that is coupled to the system bus 2108, but can be connected by other interfaces such as a parallel port, IEEE 1394 serial port, a game port, a USB port, an IR interface, and so forth.

A monitor 2144 or other type of display device is also connected to the system bus 2108 via an interface, such as a video adaptor 2146. The monitor 2144 may be internal or external to the computer 2102. In addition to the monitor 2144, a computer typically includes other peripheral output devices, such as speakers, printers, and so forth.

The computer 2102 may operate in a networked environment using logical connections via wire and/or wireless communications to one or more remote computers, such as a remote computer 2148. The remote computer 2148 can be a workstation, a server computer, a router, a personal computer, portable computer, microprocessor-based entertainment appliance, a peer device or other common network node, and typically includes many or all of the elements described relative to the computer 2102, although, for purposes of brevity, only a memory/storage device 2150 is illustrated. The logical connections depicted include wire/wireless connectivity to a local area network (LAN) 2152 and/or larger networks, for example, a wide area network (WAN) 2154. Such LAN and WAN networking environments are commonplace in offices and companies, and facilitate enterprise-wide computer networks, such as intranets, all of which may connect to a global communications network, for example, the Internet.

When used in a LAN networking environment, the computer 2102 is connected to the LAN 2152 through a wire and/or wireless communication network interface or adaptor 2156. The adaptor 2156 can facilitate wire and/or wireless communications to the LAN 2152, which may also include a wireless access point disposed thereon for communicating with the wireless functionality of the adaptor 2156.

When used in a WAN networking environment, the computer 2102 can include a modem 2158, or is connected to a communications server on the WAN 2154, or has other means for establishing communications over the WAN 2154, such as by way of the Internet. The modem 2158, which can be internal or external and a wire and/or wireless device, connects to the system bus 2108 via the input device interface 2142. In a networked environment, program modules depicted relative to the computer 2102, or portions thereof, can be stored in the remote memory/storage device 2150. It will be appreciated that the network connections shown are exemplary and other means of establishing a communications link between the computers can be used.

The computer 2102 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

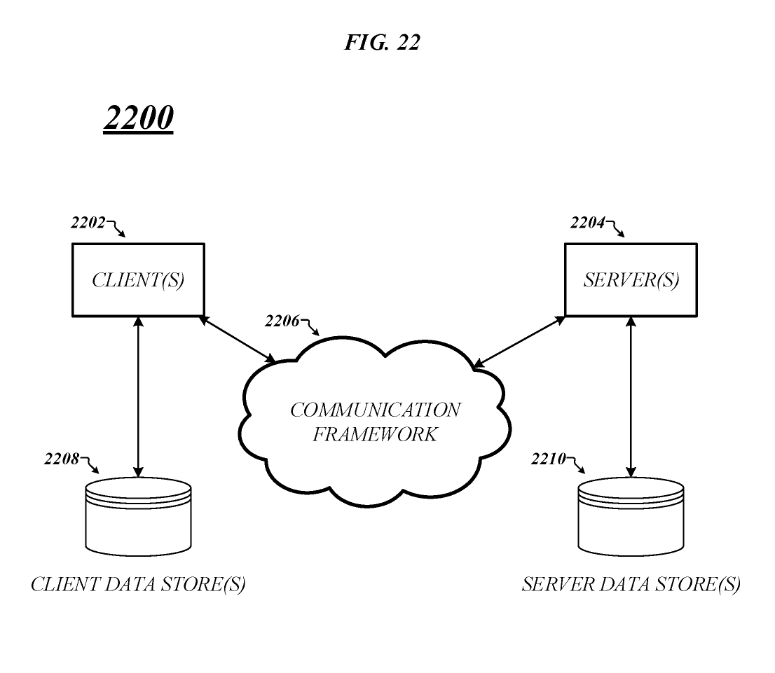

FIG. 22 illustrates a block diagram of an exemplary communications architecture 2200 suitable for implementing various embodiments as previously described. The communications architecture 2200 includes various common communications elements, such as a transmitter, receiver, transceiver, radio, network interface, baseband processor, antenna, amplifiers, filters, power supplies, and so forth. The embodiments, however, are not limited to implementation by the communications architecture 2200.

As shown in FIG. 20, the communications architecture 2200 comprises includes one or more clients 2202 and servers 2204. The clients 2202 and the servers 2204 are operatively connected to one or more respective client data stores 2208 and server data stores 2210 that can be employed to store information local to the respective clients 2202 and servers 2204, such as cookies and/or associated contextual information. In various embodiments, any one of servers 2204 may implement one or more of logic flows 1300-1700 of FIGS. 13-17, and storage medium 1800 of FIG. 18 in conjunction with storage of data received from any one of clients 2202 on any of server data stores 2210.

The clients 2202 and the servers 2204 may communicate information between each other using a communication framework 2206. The communications framework 2206 may implement any well-known communications techniques and protocols. The communications framework 2206 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 2206 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1900 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 2202 and the servers 2204. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments, from which numerous permutations and configurations will be apparent.

Example 1 is an apparatus comprising logic, at least a portion of which is implemented in hardware, the logic comprising a storage management application to manage a data store of a cloud platform. The storage management application comprising interface, indexing, and storage components. The interface component to receive a set of data via a defined interface. The indexing component to generate a current key value for a subset of data from the set of data, compare the current key value with a previous key value, and identify the subset of data as duplicate data when the current key value matches the previous key value. The storage component to create a storage object for the set of data, the storage object to include a reference for the duplicate data, associate the storage object with an object identifier, and store the storage object in the data store of the cloud platform.

Example 2 includes the subject matter of Example 1, the defined interface comprising a representational state transfer (REST) framework.

Example 3 includes the subject matter of Example 1, the indexing component to identify the subset of data as original data when the current key value is different from the previous key value. The storage component to create the storage object for the set of data, the storage object to include the original data.

Example 4 includes the subject matter of Example 1, the indexing component to create a hash of the subset of data to generate the current key value.

Example 5 includes the subject matter of Example 4, the indexing component to store the current key value to a local data store.

Example 6 includes the subject matter of Example 1, wherein the previous key value is for a subset of data from the set of data.

Example 7 includes the subject matter of Example 1, wherein the previous key value is for a subset of data from a different set of data.

Example 8 includes the subject matter of Example 1, the indexing component to retrieve the previous key value from a local data store.

Example 9 includes the subject matter of Example 1, the indexing component to retrieve the previous key value from a remote data store.

Example 10 includes the subject matter of Example 1, the interface component to send the object identifier to a mobile device in a representation state transfer (REST) response.

Example 11 includes the subject matter of Example 1, the object identifier comprising a uniform resource identifier (URI).

Example 12 includes the subject matter of Example 1, the interface component to receive a request for the set of data, and an assembler component to request the storage object from the data store for the cloud platform with a representational state transfer (REST) call that includes the object identifier.

Example 13 includes the subject matter of Example 1, the interface component to receive an access token via the defined interface.

Example 14 includes the subject matter of Example 1, the storage management application to include a verification component to validate an access token and enable, based on validation of the access token, the indexing component to generate the current key value.

Example 15 includes the subject matter of Example 14, the verification component to validate the access token through comparison of the access token to a registration store.

Example 16 is a computer-implemented method, comprising receiving a set of data via a defined interface, generating a current key value for a subset of data from the set of data, comparing the current key value with a previous key value, identifying the subset of data as duplicate data when the current key value matches the previous key value, creating a storage object for the set of data, the storage object including a reference for the duplicate data, associating the storage object with an object identifier, and storing the storage object in a data store of a cloud platform.

Example 17 includes the subject matter of Example 16, the defined interface comprising a representational state transfer (REST) framework.

Example 18 includes the subject matter of Example 16, comprising identifying the subset of data as original data when the current key value is different from the previous key value and creating the storage object for the set of data, the storage object to include the original data.

Example 19 includes the subject matter of Example 16, comprising creating a hash of the subset of data to generate the current key value.

Example 20 includes the subject matter of Example 19, comprising storing the current key value to a remote data store.

Example 21 includes the subject matter of Example 16, the object identifier comprising a uniform resource identifier (URI).

Example 22 includes the subject matter of Example 16, comprising sending the object identifier to a mobile device in a representational stat transfer (REST) response.

Example 23 includes the subject matter of Example 16, comprising receiving a request for the set of data via the defined interface and requesting the storage object from the data store for the cloud platform with a representational state transfer (REST) call that includes the object identifier.

Example 24 includes the subject matter of Example 16, comprising receiving an access token via the defined interface.

Example 25 includes the subject matter of Example 16, comprising validating an access token and enabling, based on validation of the access token, generation the current key value.

Example 26 includes the subject matter of Example 25, comprising validating the access token through comparison of the access token to a registration store.

Example 27 is one or more computer-readable media to store instructions that when executed by a processor circuit causes the processor circuit to receive a set of data via a defined interface, generate a current key value for a subset of data from the set of data, compare the current key value with a previous key value, identify the subset of data as duplicate data when the current key value matches the previous key value, create a storage object for the set of data, the storage object including a reference for the duplicate data, associate the storage object with an object identifier, store the storage object in a data store of a cloud platform.

Example 28 includes the subject matter of Example 27, the defined interface to include a representational state transfer (REST) framework.

Example 29 includes the subject matter of Example 27, with instructions to identify the subset of data as original data when the current key value is different from the previous key value and create the storage object for the set of data, the storage object to include the original data.

Example 30 includes the subject matter of Example 27, with instructions to create a hash of the subset of data to generate the current key value.

Example 31 includes the subject matter of Example 27, with instructions to retrieve the previous key value from a key value.

Example 32 includes the subject matter of Example 27, the object identifier comprising a uniform resource identifier (URI).

Example 33 includes the subject matter of Example 27, comprising sending the object identifier to a mobile device in a representational state transfer (REST) response.

Example 34 includes the subject matter of Example 27, with instructions to receive a request for the set of data via the defined interface and request the storage object from the data store for the cloud platform with a representational state transfer (REST) call that includes the object identifier.

Example 35 includes the subject matter of Example 27, with instructions to receive an access token via the defined interface.

Example 36 includes the subject matter of Example 27, with instructions to validate an access token and enable, based on validation of the access token, generation the current key value.

Example 37 includes the subject matter of Example 36, with instructions to validate the access token through comparison of the access token to a registration store.

Example 38 is an apparatus, comprising logic, at least a portion of which is implemented in hardware, the logic comprising a storage management application to manage a data store of a cloud platform. The storage management application comprising an interface component and an assembler component. The interface component to receive a request for a set of data via a defined interface. The assembler component to generate a request for a first storage object in the data store of the cloud platform based on the request for the set of data, receive the first storage object, the first storage object to include a reference for a second storage object in the data store of the cloud platform, generate a request for the second storage object based on the reference, and receive the second storage object.

Example 39 includes the subject matter of Example 38, the defined interface comprising a representational state transfer (REST) framework.

Example 40 includes the subject matter of Example 38, the request for the set of data comprising a representational state transfer (REST) call.

Example 41 includes the subject matter of Example 38, the assembler component to extract a first subset of data in the set of data from the first storage object and a second subset of data in the set of data from the second storage object.

Example 42 includes the subject matter of Example 41, the assembler component to assemble the set of data from the first and second subsets of data.

Example 43 includes the subject matter of Example 42, the interface component to send the assembled set of data to a mobile device in a representational state transfer (REST) response.

Example 44 includes the subject matter of Example 38, the request for the set of data to include an object identifier.

Example 45 includes the subject matter of Example 38, the request for the first storage object comprising a representational state transfer (REST) call.

Example 46 includes the subject matter of Example 38, the request for the second storage object comprising a representational state transfer (REST) call.

Example 47 is a computer-implemented method, comprising receiving a request for a set of data via a defined interface, generating a request for a first storage object in a data store of a cloud platform based on the request for the set of data, receiving the first storage object, the first storage object including a reference for a second storage object in the data store of the cloud platform, generating a request for the second storage object based on the reference, and receiving the second storage object.

Example 48 includes the subject matter of Example 47, the defined interface comprising a representational state transfer (REST) framework.

Example 49 includes the subject matter of Example 47, the request for the set of data comprising a representational state transfer (REST) call.

Example 50 includes the subject matter of Example 47, comprising extracting a first subset of data in the set of data from the first storage object and a second subset of data in the set of data from the second storage object.

Example 51 includes the subject matter of Example 50, comprising assembling the set of data from the first and second subsets of data.

Example 52 includes the subject matter of Example 51, comprising sending the assembled set of data to a mobile device in a representational state transfer (REST) response.

Example 53 includes the subject matter of Example 47, the request for the set of data comprising an object identifier.

Example 54 includes the subject matter of Example 47, the request for the first storage object comprising a representational state transfer (REST) call.

Example 55 includes the subject matter of Example 47, the request for the second storage object comprising a representational state transfer (REST) call.

Example 56 includes one or more computer-readable media to store instructions that when executed by a processor circuit causes the processor circuit to receive a request for a set of data via a defined interface, generate a request for a first storage object in a data store of a cloud platform based on the request for the set of data, receive the first storage object, the first storage object including a reference for a second storage object in the data store of the cloud platform, generate a request for the second storage object based on the reference, and receive the second storage object.

Example 57 includes the subject matter of Example 56, the defined interface comprising a representational state transfer (REST) framework.

Example 58 includes the subject matter of Example 56, the request for the set of data comprising a representational state transfer (REST) call.

Example 59 includes the subject matter of Example 56, with instructions to extract a first subset of data in the set of data from the first storage object and a second subset of data in the set of data from the second storage object.

Example 60 includes the subject matter of Example 59, with instructions to assemble the set of data from the first and second subsets of data.

Example 60 includes the subject matter of Example 60, with instructions to send the assembled set of data to a mobile device in a representational state transfer (REST) response.

Example 60 includes the subject matter of Example 56, the request for the set of data comprising an object identifier.

Example 63 includes the subject matter of Example 56, the request for the first storage object comprising a representational state transfer (REST) call.

Example 64 includes the subject matter of Example 56, the request for the second storage object comprising a representational state transfer (REST) call.

Example 65 is an apparatus comprising logic, at least a portion of which is implemented in hardware, the logic comprising a mobile storage application to enable a mobile device to utilize a data store of a cloud platform. The mobile storage application comprising a mobile storage component to indicate a set of data for storage to the data store of the cloud platform, a mobile indexing component to associate the set of data with an initial identifier, a mobile interface component to send a request to store the set of data via a defined interface, the request to include the set of data and the initial identifier, and receive, in response to the request, an updated identifier, and the mobile indexing component to store the updated identifier to a local data store.

Example 66 includes the subject matter of Example 65, the defined interface comprising a representational state transfer (REST) framework.

Example 67 includes the subject matter of Example 65, the updated identifier comprising the initial identifier.

Example 68 includes the subject matter of Example 65, wherein the updated identifier is different than the initial identifier.

Example 69 includes the subject matter of Example 65, the updated or initial identifier comprising a uniform resource identifier (URI).

Example 70 includes the subject matter of Example 65, the mobile indexing component to replace the initial identifier with the updated identifier in the local data store.

Example 71 includes the subject matter of Example 65, the request to store the set of data comprising a representational state transfer (REST) call.

Example 72 includes the subject matter of Example 65, the updated identifier received in a representational state transfer (REST) response.

Example 73 includes the subject matter of Example 65, the mobile interface component to send a request to retrieve the set of data via the defined interface, the request to include the updated identifier, and receive, in response to the request, the set of data. Example 74 includes the subject matter of Example 73, the request to retrieve the set of data comprising a representational (REST) call.

Example 75 includes the subject matter of Example 73, wherein the set of data is received in a representation state transfer (REST) response.

Example 76 is a computer-implemented method, comprising identifying a set of data for storage to a data store of a cloud platform, associating the set of data with an initial identifier, sending a request to store the set of data via a defined interface, the request including the set of data and the initial identifier, receiving, in response to the request, an updated identifier, and storing the updated identifier to a local data store.

Example 77 includes the subject matter of Example 76, the defined interface comprising a representational state transfer (REST) framework.

Example 78 includes the subject matter of Example 76, the updated identifier comprising the initial identifier.

Example 79 includes the subject matter of Example 76, wherein the updated identifier is different than the initial identifier.

Example 80 includes the subject matter of Example 76, comprising replacing the initial identifier with the updated identifier in the local data store.

Example 81 includes the subject matter of Example 76, the request to store the set of data comprising a representational state transfer (REST) call.

Example 82 includes the subject matter of Example 76, comprising receiving the updated identifier in a representational state transfer (REST) response.

Example 83 includes the subject matter of Example 76, comprising sending a request to retrieve the set of data via the defined interface, the request including the updated identifier, and receiving, in response to the request, the set of data.

Example 84 includes the subject matter of Example 83, the request to retrieve the set of data comprising a representational (REST) call.

Example 85 includes the subject matter of Example 83, comprising receiving the set of data in a representation state transfer (REST) response.

Example 86 includes one or more computer-readable media to store instructions that when executed by a processor circuit causes the processor circuit to identify a set of data for storage to a data store of a cloud platform, associate the set of data with an initial identifier, send a request to store the set of data via a defined interface, the request including the set of data and the initial identifier, receive, in response to the request, an updated identifier, and store the updated identifier to a local data store.

Example 87 includes the subject matter of Example 86, the defined interface comprising a representational state transfer (REST) framework.

Example 88 includes the subject matter of Example 86, the updated identifier comprising the initial identifier.

Example 89 includes the subject matter of Example 86, wherein the updated identifier is different than the initial identifier.

Example 90 includes the subject matter of Example 86, with instructions to replace the initial identifier with the updated identifier in the local data store.

Example 91 includes the subject matter of Example 86, the request to store the set of data to include a representational state transfer (REST) call.

Example 92 includes the subject matter of Example 86, with instructions to receive the updated identifier in a representational state transfer (REST) response.

Example 93 includes the subject matter of Example 86, with instructions to send a request to retrieve the set of data via the defined interface, the request to include the updated identifier, and receive, in response to the request, the set of data.

Example 94 includes the subject matter of Example 93, the request to retrieve the set of data comprising a representational (REST) call.

Example 95 includes the subject matter of Example 93, with instructions to receive the set of data in a representation state transfer (REST) response.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1. An apparatus, comprising:
logic, at least a portion of which is implemented in hardware, the logic comprising a storage management application to manage a data store of a cloud platform, the storage management application comprising:
an interface component to receive a set of data via a defined interface;
an indexing component to generate a current key value for a subset of data from the set of data, compare the current key value with a previous key value, and identify the subset of data as duplicate data when the current key value matches the previous key value; and
a storage component to create a storage object for the set of data, the storage object to include a reference for the duplicate data, associate the storage object with an object identifier, and store the storage object in the data store of the cloud platform.

2. The apparatus of claim 1, the defined interface comprising a representational state transfer (REST) framework.

3. The apparatus of claim 1, comprising:
the indexing component to identify the subset of data as original data when the current key value is different from the previous key value; and
the storage component to create the storage object for the set of data, the storage object to include the original data.

4. The apparatus of claim 1, wherein the previous key value is for a subset of data from the set of data.

5. The apparatus of claim 1, wherein the previous key value is stored in a local data store.

6. The apparatus of claim 1, wherein the previous key value is stored in a remote data store.

7. The apparatus of claim 1, the storage component to store the storage object to the data store by sending the storage object to the data store in a representational state transfer (REST) call.

8. The apparatus of claim 1, the storage management application to include a verification component to validate an access token and enable, based on validation of the access token, the indexing component to generate the current key value.

9. The apparatus of claim 14, the verification component to validate the access token through comparison of the access token to a registration store.

10. A computer-implemented method, comprising:
receiving a set of data via a defined interface;
generating a current key value for a subset of data from the set of data;
comparing the current key value with a previous key value;
identifying the subset of data as duplicate data when the current key value matches the previous key value;
creating a storage object for the set of data, the storage object including a reference for the duplicate data;
associating the storage object with an object identifier;
storing the storage object in a data store of a cloud platform.

11. The computer-implemented method of claim 10, comprising:
identifying the subset of data as original data when the current key value is different from the previous key value; and
creating the storage object for the set of data, the storage object to include the original data.

12. The computer-implemented method of claim 10, comprising creating a hash of the subset of data to generate the current key value.

13. The computer-implemented method of claim 10, the object identifier comprising a uniform resource identifier (URI).

14. The computer-implemented method of claim 10, comprising:
receiving a request for the set of data via the defined interface; and
requesting the storage object from the data store for the cloud platform with a representational state transfer (REST) call that includes the object identifier.

15. One or more computer-readable media to store instructions that when executed by a processor circuit causes the processor circuit to:
receive a set of data via a defined interface;
generate a current key value for a subset of data from the set of data;
compare the current key value with a previous key value;
identify the subset of data as duplicate data when the current key value matches the previous key value;
create a storage object for the set of data, the storage object including a reference for the duplicate data;
associate the storage object with an object identifier;
store the storage object in a data store of a cloud platform.

16. The one or more computer-readable media of claim 15, with instructions to:
identify the subset of data as original data when the current key value is different from the previous key value; and
create the storage object for the set of data, the storage object to include the original data.

17. The one or more computer-readable media of claim 15, with instructions to create a hash of the subset of data to generate the current key value.

18. The one or more computer-readable media of claim 15, with instructions to retrieve the previous key value from a remote data store.

19. The one or more computer-readable media of claim 15, the object identifier comprising a uniform resource identifier (URI).

20. The one or more computer-readable media of claim 15, with instructions to:
receive a request for the set of data via the defined interface; and
request the storage object from the data store for the cloud platform with a representational state transfer (REST) call that includes the object identifier.
